(19) United States
(12) Patent Application Publication
(10) Pub. No.: US 2026/0208563 A1
(43) Pub. Date: Jul. 23, 2026

(54) Scent Pad With Service Life Indicator for Arranging in a Ventilation Device in an Interior of a Vehicle, and Ventilation Device

(71) Applicant: Bayerische Motoren Werke Aktiengesellschaft, Muenchen (DE)

(72) Inventor: Annabelle COFFINET, Muenchen (DE)

(21) Appl. No.: 19/140,249

(22) PCT Filed: Feb. 5, 2024
(86) PCT No.: PCT/DE2024/100097

§ 371 Date: Jun. 17, 2025

(30) Foreign Application Priority Data
Feb. 24, 2023 (DE) 10 2023 104 512.1

(51) Int. Cl. B60H 3/00

(52) U.S. Cl. CPC B60H 3/0028; B60H 2003/0057; B60H 2003/0064

(57) ABSTRACT

A scent pad for arrangement within a ventilation device in an interior of a vehicle. The scent pad has a service life indicator where the service life indicator is changeable with decreasing scent saturation of the scent pad or after a predefined time period. The scent pad is arrangeable within the ventilation device and in a vicinity of an air outlet of the ventilation device where heated air of a predetermined temperature is flowable through the air outlet.

### BACKGROUND AND SUMMARY

The invention relates to a scent pad with service life indicator for arranging in a ventilation device in an interior of a vehicle, and a ventilation device.

Fragrancing systems for the interior of vehicles are well-known in the current state of the art. The simplest form is the universally known tree-shaped air fresheners or comparable fragrance agents, which are for example hung on the rear-view mirror.

Further, fragrancing devices are known, in which for example a small bottle or a vial is positioned in a holder, which is then attached to an air outlet. Fragrance is then released through the air flow into the interior of the vehicle. In addition, fragrancing devices which not visible in the interior are known, which are for example provided in the glove box or in a ventilation opening and spray fragrance into the interior via the air conditioning unit of the vehicle.

Instead of fragrances in fluid form, fragrances may also be provided in a so-called scent pad. Such a scent pad can be formed from a porous material (solid), which is soaked with a fragrance. The scent pad emits the fragrance by having air flow through the scent pad and absorbing fragrance molecules from it. In contrast to a fluid fragrance in a container, it is difficult in the case of scent pads to determine when these must be replaced, since the consumption is not evident, for example, via a fill level.

Therefore, this invention addresses the problem of providing a service life indicator for a scent pad arranged in an interior of a vehicle, by means of which the service life of the scent pad may be easily indicated.

A scent pad for arrangement within a ventilation device in an interior of a vehicle is provided, wherein the scent pad is arranged in a region and close to an air outlet, in which heated air of at least a predetermined temperature can flow past the scent pad in the direction of the air outlet, and wherein the scent pad is provided with at least one service life indicator, which is formed as a display element such that it changes a property with decreasing scent saturation of the scent pad or after a predefined period of time.

By means of the onrushing, heated air fragrance, molecules are released from the scent pad and transported by the air via an outlet of the ventilation device into the interior of the vehicle. Through the release of the fragrance molecules from the scent pad the scent saturation, that is, the number of fragrance molecules present in the scent pad, is reduced. As soon as the scent saturation has reached a predetermined threshold value, there are no longer sufficient fragrance molecules present in the scent pad to provide a fragrance of the provided region of the interior and the scent pad must be replaced. A service life indicator is provided on the scent pad to indicate this, which with decreasing scent saturation changes a property.

In one embodiment, provision is made that the change of the property comprises at least one or a combination of a fading, that is, a gradual decrease of the perceptible intensity, of the service life indicator, a gradual or erratic change in the color of the service life indicator, a change of the graphic representation of the service life indicator, a fading of the service life indicator and a gradual appearance (slowly increasing in strength) of a further service life indicator in a different place.

In one embodiment, a provision is made that the service life indicator is formed over the full surface of the entire scent pad. In an alternative embodiment, provision is made that the service life indicator is formed as an icon on a topside of the scent pad. In an alternative embodiment, provision is made that the service life indicator is formed as a sequence of letters or numbers on a topside of the scent pad. The service life indicator can thus be formed in a variety of ways without losing its function as an indication of whether the scent pad should be replaced.

In one embodiment, provision is made that the scent pad consists at least partially of a solid supplied with at least one fragrance, which is formed to output a fragrance depending on air flowing onto it and/or a predefined temperature.

In one embodiment, provision is made that the scent pad is formed of a material that has one or more fragrance types, which are emitted depending on the temperature of the air flowing past the scent pad. Thus, fragrances adapted to different temperatures can be emitted.

Furthermore, a ventilation device is provided, which is provided in an interior of a vehicle, having at least one air outlet and a scent pad arranged near the air outlet.

In one embodiment, provision is made that a sensor is additionally provided, which records a current ventilation state and communicates to a controller of the vehicle such that the controller, depending on the ventilation state, controls one or more optical and/or acoustic presentation means provided in the vehicle.

Moreover, a vehicle is provided, having the described ventilation device.

Further features and advantages of the invention arise from the subsequent description of the exemplary embodiments of the invention, on the basis of the figures, which show details according to the invention, and from the claims. The individual features can each be realized individually or in any combination in a variant of the invention.

Preferred exemplary embodiments of the invention will be described subsequently in greater detail on the basis of the attached drawings.

### BRIEF DESCRIPTION OF THE DRAWINGS

FIG. 1 shows a schematic representation of a scent pad provided with a service life indicator without need of changing, according to an embodiment of the present invention;

FIG. 2 shows the scent pad shown in FIG. 1, in which the service life indicator displays a need to change the scent pad; and

FIG. 3 shows a schematic representation of a ventilation device arranged in a vehicle and equipped with the scent pad according to an embodiment of the present invention.

### DETAILED DESCRIPTION OF THE DRAWINGS

In the following descriptions of the figures, identical elements or functions are provided with the same reference numerals.

The objective of the invention is to provide a scent pad 300 with a display option serving as a service life indicator 400, in order to display an existing or non-existing necessity to replace the scent pad 300.

A scent pad 300 is a substantially flat object, which consists of a material or contains such a material in which fragrances may be stored and emitted again. The fragrances may be a single fragrance type or several fragrance types, which are emitted depending on the temperature of the air flowing past the scent pad 300 or flowing through the scent pad 300. The material can be a porous material, which emits the fragrances when air flows through, also when the air is not heated. The material may also be formed such that it only emits the fragrances in the event of an airflow of a specified (minimum) temperature. Also, it is formed such that not all fragrances are emitted simultaneously, but rather little by little, so that the scent pad 300 may be used for a longer period of time. The time period can be set as a fixed, predefined time period, within which a predefined fragrance emission can safely occur and also, for example, the properties of the fragrance do not change. The time period may be determined, for example, under predefined standard conditions and then, for example, prints a fixed expiration date on the scent pad 300. However, since not every user has the same conduct, it may happen that, in one case the scent pad 300 can no longer provide the desired fragrance emission significantly earlier, or in another case could be used significantly longer. To fulfill these circumstances, it is provided to provide a service life indicator 400, which is arranged directly on the scent pad 300, thus visibly.

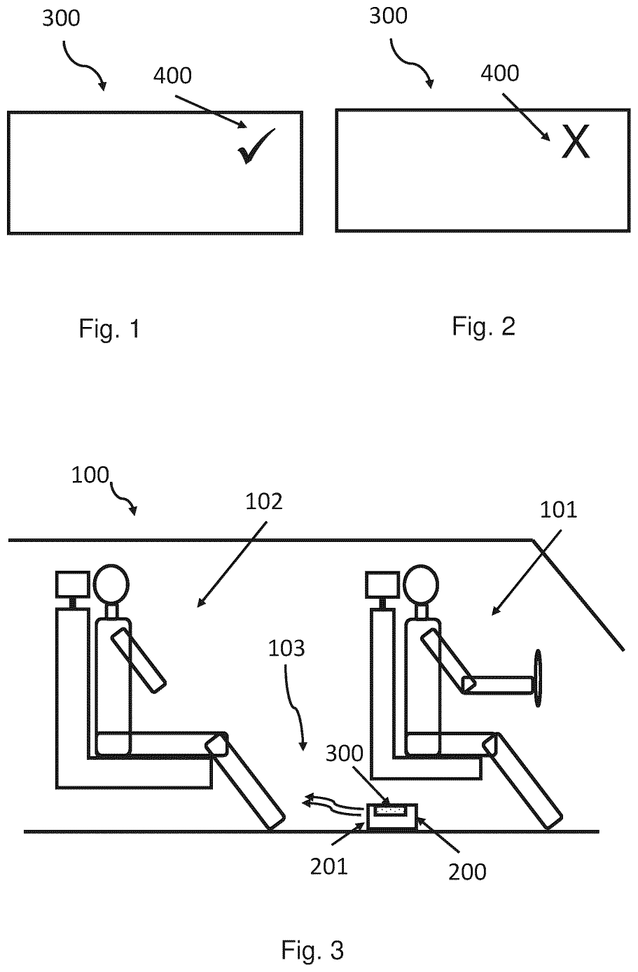

The service life indicator 400 is formed in such a way that it changes at least one of its properties with the increasing consumption of fragrance, that is, upon the reduction of the scent saturation in the scent pad 300. This property can be that it fades, thus, that the display gradually decreases in intensity. It can also gradually or erratically change its color. It may also be a property that during the fading it changes its color. It may also be a property that the service life indicator 400 changes its form, thus, for example, changes from an icon like a checkmark or a manufacturer logo to an “X” or another icon. In the process, it can only change its form, or also simultaneously change its color and/or fade. FIG. 1 shows a top view of a topside of a scent pad 300 with a life service indicator 400 formed as a checkmark. The checkmark symbolizes that the scent pad 300 does not yet need to be replaced, since there is still sufficient fragrance. FIG. 2, likewise shows a top view of a topside of a scent pad 300 with the service life indicator 400. Here, the checkmark has changed to an “X”, in order to show that the scent pad 300 should be replaced, since it no longer contains sufficient fragrance to ensure a desired fragrance emission, thus the scent saturation is too low.

It may also be a property that an icon gradually fades and another icon (as a second service life indicator 400 at another place on the scent pad 300) gradually becomes visible. This new icon can also have a different color or form. Here too, a color change may occur with the two service life indicators 400 during the usage time.

The service life indicator 400 can be formed in a variety of ways. It can be formed as an icon, as shown in FIGS. 1 and 2, or as a logo, e.g., as a manufacturer logo. However, it may also be formed as a sequence of letters or numbers. It may be in one color or multiple colors. Also, the surface(s) of the scent pad 300 itself/themselves may be formed as service life indicators 400. In this embodiment, the surface(s) of the scent pad 300 will advantageously change its/their colors when it is necessary to change the scent pad 300.

The service life indicator 400 can be provided in addition to information that is permanently visible, such as, for example, date of manufacture, sell by date etc., in order to provide a display based on the actual consumption of fragrance, about whether the scent pad 300 should be changed.

The service life indicator 400 can in addition serve as an indicator that the scent pad 300 is an original accessory, e.g., by using the manufacturer logo as a service life indicator 400.

In order to provide the properties of the service life indicator 400, suitable materials or chemical compositions are used, which are tailored to the material of the scent pad 300 and the desired property, thus the type of display of the service life. Also, the time period until a necessity to change the scent pad 300 is present, is advantageously dependent on the dimensioning of the ventilation device 200, as well as the material and fragrance that are used. The service life indicator 400 can either react to a scent saturation in the material of the scent pad 300 and change its property (based on decreasing scent saturation), or it changes its property in accordance with a (fixed) predefined period of time.

A scent pad 300 as described above can be provided within a ventilation system of a vehicle 100. In this connection, it is advantageously arranged within a ventilation device 200 and as close as possible to an air outlet in the interior of the vehicle 100, which points in the direction of passengers (users), as shown in FIG. 3. The scent pad 300 is, for example, pluggable, clippable, mountable, magnetically attachable, arranged in the ventilation device 200, and thus replaceable. The scent pad 300 is arranged such in the ventilation device 200 that it is preferably not visible for the passengers of the vehicle 100.

The scent pad 300 provided here is advantageously provided in a ventilation device 200, which serves as a foot warmer 200. The foot warmer 200 is provided below a vehicle seat, in particular a vehicle seat arranged in a front region 101 of the vehicle 100. The air outlet 201 of the foot warmer 200 points in the direction of the rear region 102, so that the foot warmer 200 heats up and emits air concentrated with fragrance in the direction of the foot space 103 of a passenger of the rear region 102, as indicated in FIG. 3.

As also indicated in FIG. 3, the scent pad 300 is arranged at an edge region of the foot warmer 200, preferably an upper edge region. This facilitates an easy replacement of the scent pad 300, by opening an upper region of the foot warmer 200. The scent pad 300 is advantageously arranged in the foot warmer 200 such that the service life indicator 400 is directly visible when the upper region of the foot warmer 200 is opened.

The foot warmer 200 can be provided exclusively for outputting heated air. In an alternative embodiment, it can also be provided for outputting non-heated or cooled air. In this case, it is then advantageously designed such that separate ventilation channels are provide for heated and non-heated or cooled air. Heated air is understood to be air that can be used to heat up the feet of a passenger of the vehicle 100. A corresponding minimum temperature can be defined by a person skilled in the art and, for example, be based on empirical values or the like.

Advantageously, the scent pad 300 is arranged in a region of the foot warmer 200 in which only warm air flows, in order to emit the least possible amount of fragrance by a non-heated airflow, which would shorten the service life.

Moreover, existing or specially provided presentation means in addition to the fragrance emission in the vehicle interior can underscore the fragrance experience. These can be controlled by a controller present in the vehicle 100. Advantageously, at least one sensor is additionally provided, which, for example, is placed on or in the air inlet 201, in particular in the region of the scent pad 300 and measures one or a plurality of parameters, which are used to control the presentation. The sensor should advantageously not be visible from the outside, wherein this is only advantageous for optical reasons. It is to be placed in an area at which it is as optimally arranged as possible, in order to record the parameters. This can be a flow speed and/or a temperature and/or a flow direction and/or a fragrance type. Depending on the recorded parameters, the sensor can then send corresponding information or signals to the controller of the vehicle 100, which then in turn controls the presentation means correspondingly. The control occurs, for example, depending on and tailored to the fragrance type at a specified temperature.

For example, a sound system present in the vehicle 100 or separately provided or one or more loudspeakers of the sound system may be used as presentation means. Alternatively, or in addition, for example a light system present in the vehicle 100 or separately provided or one or more illuminants thereof may be used as presentation means.

### LIST OF REFERENCE CHARACTERS

100 vehicle
101 front region/driver
102 rear region/back seat
103 foot space between 101 and 102
200 ventilation device, foot warmer
201 air outlet
300 scent pad
400 service life indicator

1.-9. (canceled)

10. A scent pad for arrangement within a ventilation device in an interior of a vehicle, comprising:
a service life indicator, wherein the service life indicator is changeable with decreasing scent saturation of the scent pad or after a predefined time period;
wherein the scent pad is arrangeable within the ventilation device and in a vicinity of an air outlet of the ventilation device and wherein heated air of a predetermined temperature is flowable through the air outlet.

11. The scent pad according to claim 10, wherein the service life indicator is changeable by at least one of, or a combination of:
a fading of the service life indicator;
a gradual or an erratic changing of a color of the service life indicator;
a changing of a graphic representation of the service life indicator; and
a gradual fading of the service life indicator and a gradual appearance of a further service life indicator at a location that is different from a location of the service life indicator.

12. The scent pad according to claim 10, wherein the service life indicator is formed on an entirety of the scent pad or wherein the service life indicator is formed as an icon on a topside of the scent pad or wherein the service life indicator is formed as a sequence of letters or numbers on the topside of the scent pad.

13. The scent pad according to claim 10, wherein the scent pad consists at least partially of a solid supplied with a fragrance and wherein the solid outputs the fragrance depending on air flowing onto the solid and/or depending on a predefined temperature.

14. The scent pad according to claim 10, wherein the scent pad is formed of a material that has one or more fragrance types which are emitted depending on a temperature of air flowing past the scent pad.

15. A ventilation device, comprising:
an air outlet; and
the scent pad according to claim 10, wherein the scent pad is disposed in a vicinity of the air outlet;
wherein the ventilation device is disposed in an interior of a vehicle.

16. The ventilation device according to claim 15, wherein the ventilation device is a foot warmer which is disposed below a vehicle seat that is disposed in a front region of the vehicle such that outflowing heated air from the air outlet is output in a direction of a foot space of a rear region of the vehicle.

17. The ventilation device according to claim 15, further comprising a sensor, wherein a current ventilation state is recordable or settable by the sensor, wherein the sensor communicates with a controller of the vehicle, and wherein an optical presentation or an acoustical presentation disposed in the vehicle is controllable by the controller depending on the current ventilation state,

18. A vehicle, comprising:
a ventilation device disposed in an interior of the vehicle, wherein the ventilation device comprises:
an air outlet; and
the scent pad according to claim 10, wherein the scent pad is disposed in a vicinity of the air outlet.
